(19) United States
(12) Patent Application Publication
(10) Pub. No.: US 2022/0067650 A1
(43) Pub. Date: Mar. 3, 2022

(54) EQUIPMENT FOR AIDING THE TRACEABILITY OF AGRI-FOOD PRODUCTS

(71) Applicant: SISSPRE - SOCIETA' ITALIANA SISTEMI E SERVIZI Dl PRECISIONE S.R.L., Milano (IT)

(72) Inventors: Andrea Polo Filisan, Milano (IT); Fabio Mario Scalise, Milano (IT)

(21) Appl. No.: 17/418,416

(22) PCT Filed: Dec. 27, 2019
(86) PCT No.: PCT/IB2019/061404

§ 371 Date: Jun. 25, 2021

(30) Foreign Application Priority Data
Dec. 28, 2018 (IT) 102018000021415

(51) Int. Cl. G06Q 10/08; G06Q 30/00; H04L 29/08; B65D 43/02

(52) U.S. Cl. CPC G06Q 10/0833; G06Q 30/018; B65D 2401/05; B65D 43/0235; H04L 67/12

(57) ABSTRACT

Equipment for aiding the traceability of agri-food products, includes: a frame, which can be connected to a container, an image detector device, fitted to the frame and oriented so that it frames the container; a motion sensor fitted to the frame and configured to detect movements within a surveillance region around the container; a satellite positioning device; a storage device; and a processing unit. The image detector device is coupled to the motion sensor and is configured to acquire a reference image in response to a movement detected by the motion sensor. The processing unit is configured to associate the reference image with coordinates detected by the satellite positioning device and a timestamp, and to store the reference image, the coordinates detected by the satellite positioning device, and the timestamp in the storage device.

### CROSS-REFERENCE TO RELATED APPLICATIONS

This Patent Application claims priority from Italian Patent Application No. 102018000021415 filed on Dec. 28, 2018, the entire disclosure of which is incorporated herein by reference.

### TECHNICAL FIELD

The present invention concerns equipment for aiding the traceability of agri-food products.

### BACKGROUND ART

As is well known, the traceability of products along the supply chain is becoming increasingly important in the agri-food sector. On the one hand, in fact, in many countries traceability is required by food hygiene and safety regulations. On the other hand, it is in the interests, above all, of companies that produce high quality products to be able to best guarantee the public of the origin of the raw materials and the nature of the processing carried out, as well as of their integrity up to marketing. In essence, therefore, there is a need to reduce the scope for possible fraud implemented by substituting or adding raw materials of an origin other than the one declared. This is also all in aid of the fundamental protection of the final consumer who cares about quality.

Numerous solutions have, therefore, been developed to assist in the certification of the origin and processing of marketed products. In general, however, it is precisely the initial link in the traceability chain of agricultural products, namely harvesting, which has a weak point that makes certification difficult and still leaves ample room for attempted fraud. This is particularly true, for example, in the harvesting of fruit of all kinds and for many kinds of vegetables. The difficulties arise from the obvious lack of technological infrastructure at harvesting sites, which currently prevents the necessary operations for product certification from being carried out.

### DISCLOSURE OF INVENTION

The purpose of the present invention is to provide equipment for aiding the traceability of agri-food products that makes it possible to overcome, or at least to mitigate, the limitations described.

According to the present invention, therefore, equipment is provided for aiding the traceability of agri-food products essentially as defined in claim 1.

### BRIEF DESCRIPTION OF THE DRAWINGS

Further features and advantages of the present invention will become clear from the following description of the non-limiting embodiments thereof, with reference to the accompanying drawings, in which:

FIG. 1 is a prospective view of a piece of equipment for aiding the traceability of agri-food products according to one embodiment of the present invention;

FIG. 2 is a side view of the equipment in FIG. 1;

FIG. 3 shows a simplified block diagram of the equipment in FIG. 1;

FIGS. 4a-4c show alternative examples of one element of the equipment in FIG. 1 in use;

FIG. 5 shows the equipment of FIG. 1 in use;

FIG. 6 is a simplified flow diagram relating to a first procedure carried out by the equipment in FIG. 1;

FIG. 7 is a simplified flow diagram relating to a second procedure carried out by the equipment in FIG. 1;

FIG. 8 is a schematic side view of a piece of equipment for aiding the traceability of agri-food products according to a different embodiment of the present invention; and

FIG. 9 is a simplified block diagram of a system for tracing agri-food products incorporating equipment of the type shown in FIG. 1.

### BEST MODE FOR CARRYING OUT THE INVENTION

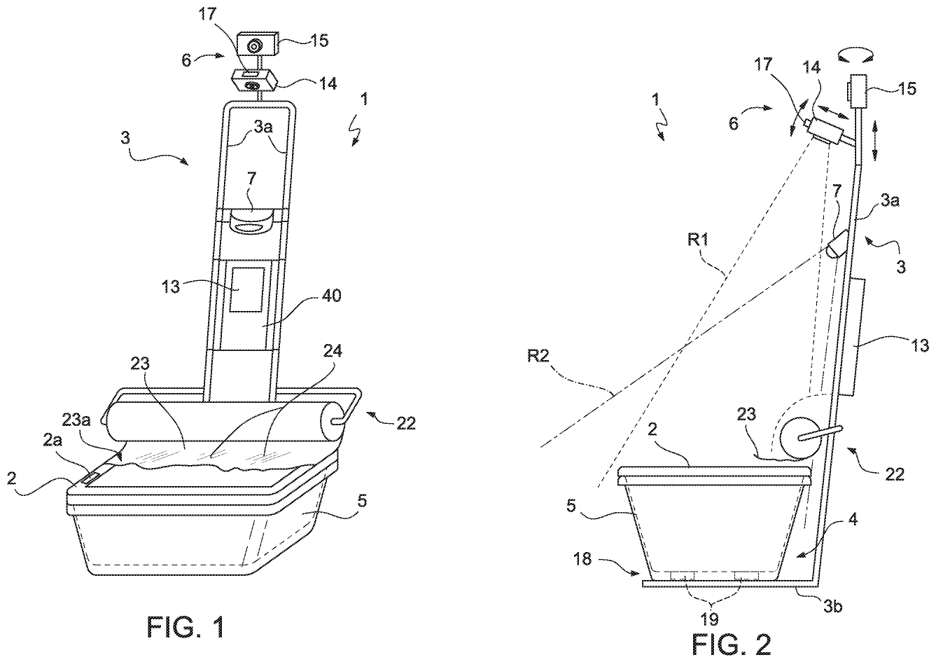

With reference to FIGS. 1 and 2, the equipment for aiding the traceability of agri-food products is indicated, as a whole, with the number 1. The equipment 1 is especially designed to support traceability during the harvesting of fruit and vegetables of all kinds.

The equipment 1 comprises a container 2 for harvesting fruit and a frame 3, provided with connecting members 4 for connecting it to the container 2.

The container 2 may be any container that is generally open upwards and may be used for harvesting fruit or vegetables. In the example in FIG. 1, the container 2 is a stackable box with other boxes of the same type (generally suitable for holding a few kilos of product and, therefore, easily transportable by hand). Alternatively, the container 2 may be a standard container (BIN) suitable for containing larger quantities of product and that may be moved using mechanical forks. In one embodiment, the container 2 is provided with an identification label 2a, which contains a unique identification code and may either be optically readable (e.g. with a barcode) or electromagnetic (e.g. RFID tag).

In one embodiment, the frame 3 comprises a vertical support 3a defined by one or more uprights fixed to the connecting members 4, which are configured, in particular, to enable the frame 3 to be reversibly connected to the container 2. In the embodiment in FIG. 1, in particular, the connecting members 4 comprise a base 5 designed to receive the container 2 and fixed to a ground support portion 3b of the frame 3. The base 5, in particular, may be defined by a stackable box that is identical to the container 2. In this way, the coupling between the frame 3 and the container 2 is quick and easy and, in addition, the positioning of the container 2 is precise and may be repeated. In an embodiment not shown, the base may be planar, for example with an essentially horizontal plate for receiving, and supporting, the container 2. Alternatively, the connecting members may comprise clamps, grippers, or coupling or screw-in fastening systems, and the like.

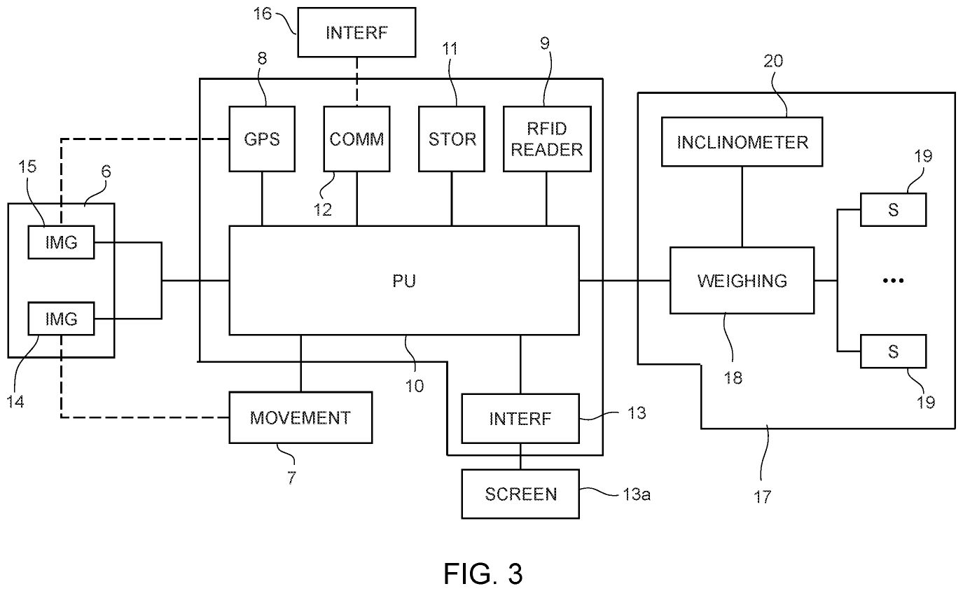

Also with reference to FIG. 3, the equipment 1 comprises, in addition, an image detector device 6, a motion sensor 7, a satellite positioning device 8, an identification tag reader 9, a processing unit 10, equipped with a storage device 11, and a wireless communication module 12, all fitted to the frame 3. A local command interface 13 is equipped with a screen 13a and may be supported by the frame 3 and connected, via a cable, to the processing unit 10 or it may be defined by a mobile device, such as a smartphone or tablet, and communicably coupled to the processing unit 10 via the wireless communication module 12, e.g. using the Bluetooth communication standard. Alternatively, a remote interface 16 may be communicably coupled to the processing unit 10 for the same purpose via the wireless communication module 12. At least the satellite positioning device 8, the identification tag reader 9, the processing unit 10, the storage device 11, the wireless communication module 12, and the command interface 13 may be housed inside the same housing 40 fixed to the frame 3.

In one embodiment, the image detector device 6 comprises image sensors 14, 15, provided with their respective fixed or variable optics, not shown, and an illuminator 17.

The image sensors 14, 15 may be essentially visible band sensors that are, such as CMOS or CCD sensors, or infrared or ultraviolet radiation sensors, laser scanners or, in general, any type suitable for being fitted to the frame 3.

The image sensor 14 is oriented towards the base 5 so as to frame an observation region R1 including the opening of the container 2 when the latter is placed in the base 5, as shown in FIG. 2. The image sensor 14 is configured to acquire individual images and/or image sequences for a programmed period of time based on the type of activity to be observed and traced in response to movements detected by the motion sensor 7 and to remain on standby in the absence of signals indicating movements detected by the motion sensor 7. The coupling with the motion sensor 7 may be direct or indirect via the processing unit 10 (FIG. 3). In other words, the image sensor 14 may respond directly to the signals coming from the motion sensor 7 or commands generated by the processing unit 10 in response to signals coming from the motion sensor 7. In one embodiment, the image acquisition is carried out with a delay, for example, of a few seconds, with respect to the moments wherein the motion sensor 7 detects a movement or the last of a sequence of movements in its sensitive range.

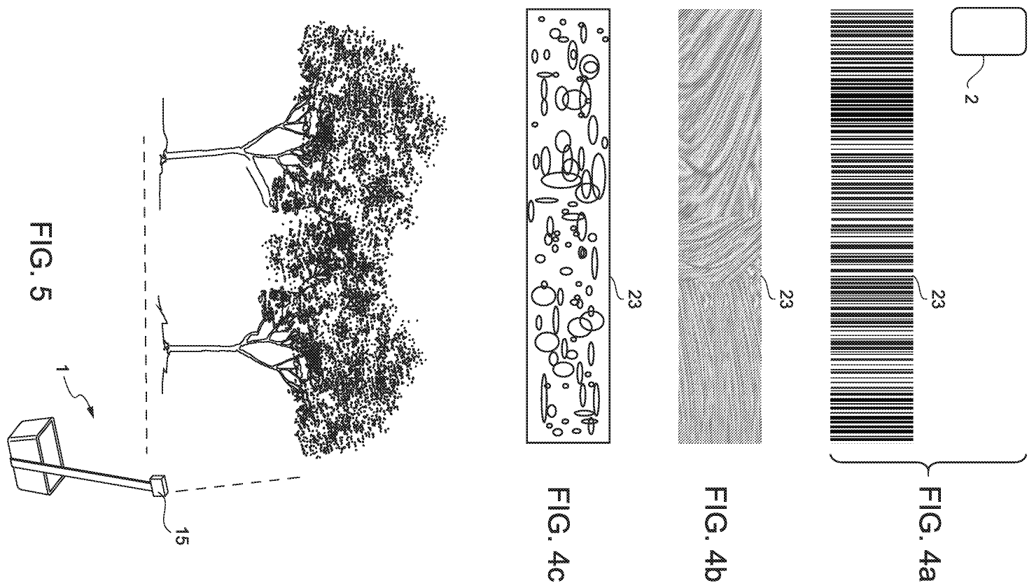

The image sensor 15 is oriented so that it can take landscape images of a portion of the land around the equipment 1 where the harvesting is carried out, in particular of trees from which fruit is harvested, as well as installations, fences, portions of buildings, and any objects that may be present (FIG. 4). The image sensor 15 may be activated manually via commands provided by an operator via the command interface 13 or in response to a spatial coordinate change indicated by the satellite positioning device 8 (e.g. as a result of displacements exceeding a programmed minimum distance).

In an alternative embodiment that is not shown, it is possible to use a single image sensor that may be oriented either towards the base 5, or towards the surroundings and/or variable optics that enable to manually or automatically switch between different frames on the basis of a pre-set mode.

The motion sensor 7 may be, for example, a passive infrared sensor, a DMT (“Digital Motion Technology”) sensor, a microwave sensor, an ultrasonic sensor, or a combination of these. The motion sensor 7 is oriented towards the base 5 to detect movements in a surveillance region R2, including at least a portion of the observation region R1 framed by the image detector device 6. In particular, the motion sensor 7 is configured so as to be activated by inserting the container 2 into the base 5 and by pouring the harvested fruit into the container 2, which is already in the base 5. In practice, therefore, the motion sensor 7 enables to identify the introduction of the container 2, empty or full, in the base 5 and the actions involving a change in the contents of the container 2 when it is in the base 5.

As mentioned, in addition, the motion sensor 7 determines, directly or indirectly and via the processing unit 10, the acquisition of images by the image sensor 14.

The satellite positioning device 8 is, for example, a GPS locator or GNSS navigator and is communicably coupled to the processing unit 10 to provide, in response to a command, a pair of spatial coordinates (longitude and latitude).

The identification tag reader 9 is of a type that is suitable for reading the identification labels 2a on the container 2. Depending on the identification labels 2a used, the identification tag reader 9 may comprise, for example, a barcode reader or an RFID tag reader. In the first case, the identification tag reader 9 may be implemented by the processing unit 10 and the image sensors 14, 15 if the identification labels 2a are affixed to portions of the containers 2 that are visible during harvesting. In this case, the processing unit 10 may extract portions of the image corresponding to the identification labels 2a and recognise them.

The equipment 1 comprises, in addition, a weighing device 17, configured to determine the weight of the container 2 placed in the base 5 (FIGS. 2 and 3). The weighing device 17 comprises a processing module 18, one or more weight sensors 19, arranged so as to be loaded when the container 2 is in the base 5, and an inclinometer 20, rigidly fixed to the frame 3. In one embodiment, the processing module 18 may be integrated into the processing unit 10. The weight sensors 19 may, for example, be load cells placed under the base 5 near the vertexes. The inclinometer 20 may be advantageously based on an accelerometer or on a multi-axial, micro electro-mechanical gyroscope.

The processing unit 10 cooperates with the weight sensors 19 and with the inclinometer 20 to determine the weight of the container 2 placed in the base 5. In particular, the processing unit 10 determines an inclination of the container 2 with respect to a horizontal plane, using an inclination signal provided by the inclinometer 20 and/or by combining the raw weight values provided by the weight sensors 19. The raw weight values are then corrected by the processing unit 10, according to the determined inclination. In addition, the processing unit 10 may subtract the tare of the container 2 using a value recorded in the storage device 11 or by directly weighing the empty container, if possible.

In one embodiment (FIGS. 1 and 2), the equipment 1 comprises a dispenser 22 that provides an anti-tamper or tamper proof film 23, which may be applied to close the container 2 and that is destroyed when removed. The dispenser 22 comprises a roll of anti-tamper film 23 supported by the frame 3 so that it swivels around an axis parallel to the base 5 at a height that is slightly higher than the height of the container 2 that is housed in the base 5. The anti-tamper film 23 can thus be extended and applied to close the container 2 before the container 2 itself is removed from the base 5. In one embodiment, the anti-tamper film 23 is made of a transparent perforated and biodegradable polymer material and has weakening lines 24. In practice, once applied, the anti-tamper film 23 breaks along the weakening lines 24 upon an attempt to remove it, revealing an anomaly. In addition, the anti-tamper film 23 has, on one face 23a, visible graphic signs 25 that do not repeat or repeat across a section that is greater than the length of film required to close the container 2 (examples of graphic signs 25 are shown in FIGS. 4a-4c; FIG. 4a also shows, merely by way of example, the dimensions of the container 2 in relation to the anti-tamper film 23). The graphic signs 25 are made so that, once the container 2 is closed, the appearance presented towards the image sensor 14 is unique (or, in any case, difficult to reproduce). An optical examination of the graphic signs 25, therefore, makes it possible to determine whether the anti-tamper film 23 has been replaced. The graphic signs 25 may be realistic or abstract images or they may comprise graphic codes, such as linear or two-dimensional barcodes.

The processing unit 10 is configured to associate the images provided by the image sensor 14 with the coordinates detected by the satellite positioning device 8 at the time of detection and a timestamp that is synchronised with a time reference system, e.g. via the internet. In addition, the processing unit 10 stores the images acquired in the storage device 11 together with the respective coordinates and timestamps. At the same time, the processing unit 10 also stores, in the storage device 11, the unique identification code associated with the container 2, the subject of the acquired image, and provided by the identification label reader 9.

The processing unit 10 is provided with an image processing module 30 configured to carry out feature extraction and image comparison (identity verification) operations. For this purpose, the image processing module 30 uses processing techniques and algorithms such as orientation, dimensional and geometrical normalisation (e.g. taking the edges of the container 2 and/or specially applied markers as reference), brightness equalisation, colour equalisation, noise reduction, smoothing, contour recognition, detection of elements with specific colour bands (e.g. fruits with different degrees of ripeness), segmentation of the image into sub-areas, pattern recognition, standards definition and measurement of standards to determine whether the images are identical or different. The techniques and algorithms used may be optimised based on the graphic signs 25 on the anti-tamper film to the type of fruit or vegetable harvested (grapes, olives, or tomatoes, etc.). The operations of orientation adjustment and dimensional and geometric normalisation may be carried out by taking elements of various types present in the image, and useful for characterising the positioning of the image itself in space and time, as a reference. As a non-limiting example, elements of the images that are useful for this purpose include: features of the type of ground or support base (grassy meadow, transport vehicle bed, asphalt area, or differently paved area), fixed landmarks on the ground (road markers, signposts, road signs, distinctive features of the area such as buildings, portions of wall, fences, poles, and overhead line pylons) and characteristic and unique elements (parts of machinery and various pieces of equipment).

The processing unit 10 also uses the image processing module 30 to estimate a product volume inside the container placed in the base 5 from the images acquired by the image sensor 14, and to determine the weight of the container 2 based on the estimated product volume and information on the product's features that are stored in the storage device 11. The processing unit 10 thus integrates the weighing device 17.

Via the image processing module 30, the processing unit 10 is also able to recognise foreign objects that may have been introduced into the container 5 by mistake or as a result of an attempt at fraud (e.g. stones or different amounts of fruit). In particular, the storage device 11 contains admissible values of recognition parameters for the identification of agri-food product units (e.g. minimum and maximum dimensions on one or more axes, shape parameters, or colour bands, etc.) and the image processing module 30 identifies the presence of objects that are not compatible with the admissible values of the recognition parameters.

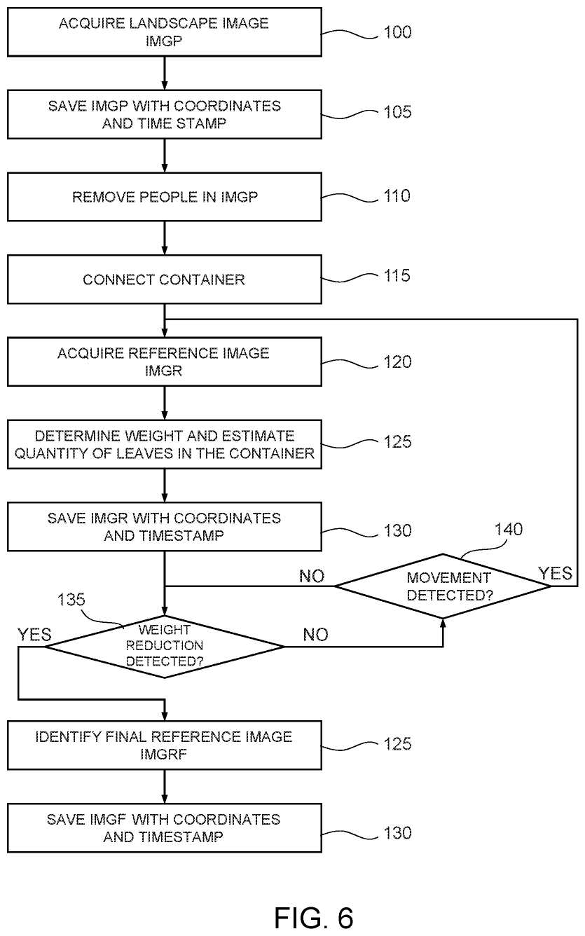

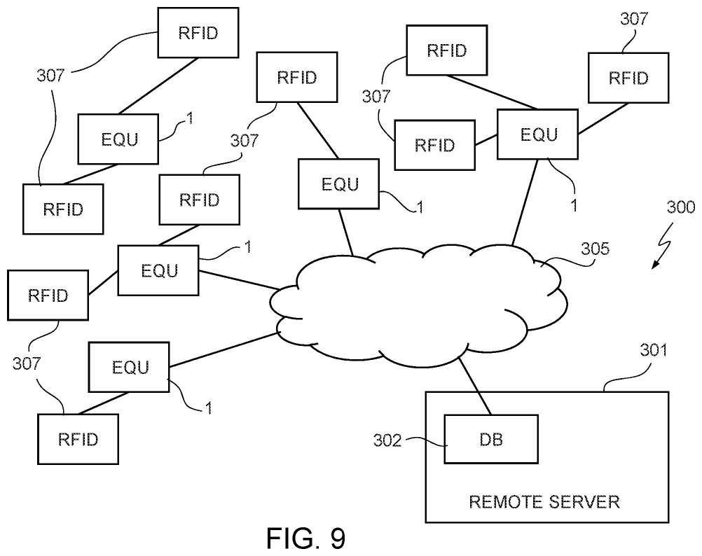

As shown in FIG. 5, in use, the equipment 1 is placed near a harvesting area of agricultural land and is operated (manually at the location or remotely via a network connection) before harvesting begins. Appropriate diagnostic programmes present in the equipment signal to the operator any operating anomalies both in direct mode (via screen or LCD display) and via network connection to a remote control unit (see, for example, the remote server 301 in FIG. 9). With reference to FIG. 6, the satellite positioning device 8 detects spatial coordinates that correspond to a displacement, from the last location, that is greater than the programmed minimum distance and the image sensor 15 is activated accordingly. Alternatively, the image sensor 15 is manually activated via the command interface 13. In both cases, the image sensor 15 detects a landscape image IMGP around the equipment 1 (block 100), including plants before harvesting. The landscape image IMGP is saved by the processing unit 10 in the storage device 11 together with the coordinates provided by the satellite positioning device 8 and the timestamp (block 105). At this stage, the processing unit 10 may identify the presence of people in the landscape image IMGP and remove them or make them unrecognisable to avoid confidentiality violations (block 110).

Next (block 115), a container 2 is connected to the frame 3. The connection may be obtained by placing the container 2 in the base 5 or, if the container 2 is a standard container (BIN) and there is no base 5, by applying the frame 3 with the connecting members (grippers or clamps, etc.).

The act of connecting activates the motion sensor 7, which triggers the acquisition of a reference image IMGR by the image sensor 14 (block 120) and the determination of the weight of the container 2 (block 122). The weight of the container 2 may be determined either directly by the weighing device 17 or, if the weighing device 17 is not available, indirectly by the processing unit 10 based on the reference image IMGR. In particular, the processing unit 10 is configured to estimate the volume taken up by the product in the container 2 using the image processing module 30 and product's average specific gravity data, which are stored in the storage device 11. In one embodiment, in addition, the processing unit 10 is optionally configured to compare the weight of the container 2 determined by the weighing device 17 with the weight derived from the estimated volume taken up by the product in the container 2. In this way it is possible to assess the amount of foreign material or waste present, such as leaves or twigs, and whether defoliation should be carried out directly in the field to optimise harvesting and transport to the processing plant. The reference image IMGR and weight information are then saved in the storage device 11 with the coordinates provided by the satellite positioning device 8 and a respective timestamp (block 125).

As long as the container 2 remains connected to the frame 3 (block 130, output NO), movements inside the surveillance region R2 of the motion sensor 7 are detected (block 135, output YES) and trigger the acquisition and saving of a new reference image IMGR (blocks 120-130). Movements may generally correspond to the addition of products to the container 2 from other containers or harvesting means, or to the sealing of the container 2 with a corresponding portion of the anti-tamper film 23. The anti-tamper film portion is uniquely identifiable and, since it is almost, if not completely, impossible to replace it with an identical portion, the possibility of tampering with the contents is greatly reduced.

If no movements are detected (block 135, NO output), the image sensor 14 will remain on hold to minimise power consumption.

When the container 2 is separated from the frame 3, the weighing device 17 detects a weight decrease (block 130, output YES), the processing unit 10 identifies the last stored reference image (block 140) and saves it in the storage device 11 as the final reference image IMGRF, with its corresponding spatial coordinates, timestamps, identification codes, and, possibly, weight (block 145). Alternatively, the final reference image IMGRF may also be acquired and marked as such in response to a command provided by an operator via the local command interface 13 or via a remote command interface 13.

The final reference image IMGRF, in practice, corresponds to a (uniquely defined) portion of the anti-tamper film 23, if used, or of the product configuration in the container 2. In both cases, the final reference image IMGRF represents the state of the filled container 2 before it is handed over for the successive transport and/or processing steps.

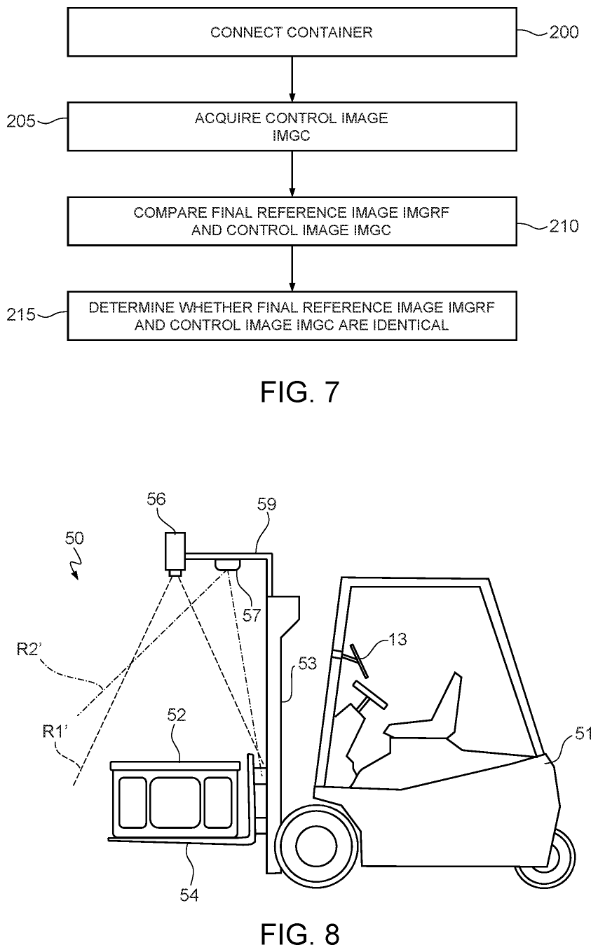

With reference to FIG. 7, before placing the harvested product in a transport container (e.g. from a harvesting box to a container or BIN), or when entering a processing plant, the container 2 is reconnected to the frame 3 (block 200) and the image sensor 14 acquires a control image IMGC in response to a command from the processing unit 10 (block 205). Using the frame 3, the point of view of the control image IMGC coincides with the point of view of the IMGRF final reference image. The two images may then be easily compared by the image processing module 30 of the processing unit 10 (block 210). As mentioned above, the image processing module 30 for the comparison may use processing techniques and algorithms such as orientation, dimensional and geometrical normalisation (e.g. taking as reference the edges of the container 2 and/or specially applied markers), brightness equalisation, colour equalisation, noise reduction, smoothing, contour recognition, detection of elements with specific colour bands (e.g. fruits with different degree of ripeness), segmentation of the image into sub-areas, pattern recognition, standards definition and measurement of standards. Recognition algorithms may generally be applied both when the container 2 is sealed with the anti-tamper film 23 and when the container is open. In the first case, the image processing module 30 may directly compare the appearance of the graphic signs 25 on the anti-tamper film 23 as shown in the acquired images or, if there is a code on the anti-tamper film 23, the code may be decoded and the comparison may be carried out by the processing unit 10 on the decoding results.

The comparison is carried out by the image processing module 30 and by the processing unit 10 by applying programmed tolerance thresholds to take into account possible discrepancies due to different lighting conditions and possible product movements in the container, if the anti-tamper film is not used 23.

Based on the comparison and tolerance thresholds applied, the processing unit 10 determines (confirms or denies) whether the control image IMGC and the final reference image IMGRF, which is associated with the container 2 and stored in the storage device 11 (block 215), are identical.

In this way, the equipment 1 enables the tracing of food products, in particular fruit and vegetables, from the moment of harvesting, thus avoiding the lack of technological infrastructure at the harvesting points, which often prevents the operations necessary for certification from being carried out. The equipment 1 therefore makes it possible to reduce the possibility of attempted fraud and, in general, the risk that the product delivered for successive processing steps is of a different origin from the one declared. The IMGRF final reference image and control image IMGC data can be made available to a remote station for any additional processing and integration into the traceability chain. In addition, the control is carried out almost completely automatically, without interfering with employees' activities.

With reference to FIG. 8, a piece of equipment 50, in accordance with a different embodiment of the present invention, is fitted to a motorised forklift 51 and comprises a frame 53 provided with connecting members 54 for connecting to a container 52 for harvesting fruit, here a standard container (BIN). In the example described, the frame 52 and the connecting members 54 are defined by lifting masts and forklift forks 51 respectively. In addition, the equipment 50 comprises, an image detector device 56 and a motion sensor 57 connected to the frame 52 by a bracket 59. The image detector device 56 is oriented towards connecting members 54 so as to frame an observation region R1′ including the opening of the container 52 when it is placed on the forks of the forklift 51, i.e. when it is coupled to the connecting members 54.

The motion sensor 57 is oriented towards the connecting members 54 to detect movements in a surveillance region R2′ including at least a portion of the observation region R1′ framed by the image detector device 56. In particular, the motion sensor 57 is configured so as to be activated by the act of positioning the container 52 on the connecting members 54 (forks) and by the pouring of harvested fruit into the container 52, which is already positioned on the forks. As in the example in FIGS. 1 and 2, therefore, the motion sensor 57 enables to identify the introduction of the container 52, empty or full, and the actions that imply a change in its contents.

Though not shown here, for the sake of simplicity, there is a satellite positioning device 8, an identification tag reader 9, a processing unit 10 with storage device 11, and a wireless communication module 12, essentially as already described with reference to FIG. 3. The local command interface 13 can be placed on board the forklift 51. As in the example above, the processing unit 10 associates the reference images with the coordinates detected by the satellite positioning device 8 and a timestamp, and stores the reference images, the coordinates detected by satellite positioning device 8, and the timestamp in the storage device 11.

FIG. 9 schematically shows a system 300 for the traceability of agri-food products that comprises a plurality of pieces of equipment 1, which are essentially of the type already described, and a remote server 301, which hosts a database 302. The remote server 301 can be connected to each piece of equipment 1 via an extended communication network 305 (e.g. the internet) and their respective wireless communication modules. Different examples of this equipment 1 may differ from each other, for example, in aspects such as the shape of the frame or the structure of the base, including in relation to the type of container used, but they are still equipped with the photograph-taking, georeferencing, and timestamping functions to document the configuration of the containers before transport. The system 300 can also comprise identification labels 307, e.g. RFID tags, for the unique identification of the specific site of origin. The identification labels 307 may be applied to individual plants or groups of plants, or they can be associated with portions of the harvesting land. The identification labels 307 can be read by the identification tag readers of the equipment 1 and be associated with the reference and control images acquired when the equipment 1 is used, together with other information.

The information stored in the storage devices of the equipment 1 (reference images, control images, container identification codes, spatial coordinates, timestamps, and weight data) is transferred to the database 302 when the connection via the extended communication network 305 is available, since harvesting areas are frequently not covered by these services, or are not continuously covered, meaning that there are significant service disruptions. Once uploaded into the database 305, the information is incorporated into the traceability chain and is available to document the integrity of the products from the first steps of harvesting, to the benefit of both consumers and monitoring authorities.

It is clear that modifications and variations can be made to the equipment described herein while remaining within the scope of protection defined by the attached claims.

1. Equipment for aiding traceability of agri-food products, comprising:
a frame, provided with connecting members to a container for harvesting agri-food products;
an image detector device, fitted to the frame and oriented so that, when a container is connected to the frame, the container is within an observation region framed by the image detector device;
a motion sensor fitted to the frame and configured to detect movements within a surveillance region including at least a portion of the observation region framed by the image detector device;
a satellite positioning device;
a storage device;
a processing unit;
wherein the image detector device is coupled to the motion sensor and is configured to acquire at least a reference image in response to a movement detected by the motion sensor;
and wherein the processing unit is configured to associate the reference image with coordinates detected by the satellite positioning device and a timestamp and to store the reference image, the coordinates detected by the satellite positioning device, and the timestamp in the storage device.

2. The equipment according to claim 1, comprising a container for harvesting agri-food products connected to the frame, the container being open upwards.

3. The equipment according to claim 2, comprising an identification tag reader, wherein the container is provided with an identification tag-identifiable by the identification tag reader.

4. The equipment according to claim 3, wherein the processing unit is communicably coupled to the identification tag reader and is configured to associate the reference image acquired by the image detector device with an identification code of the identification tag on the container.

5. The equipment according to claim 2, comprising a dispenser supplying an anti-tamper film, applicable to close the container.

6. The equipment according to claim 5, wherein the anti-tamper film has weakening lines, so that, once applied, the anti-tamper film breaks along the weakening lines upon a removal attempt.

7. The equipment according to claim 5, wherein the anti-tamper film has, on one face, graphic signs that do not repeat or repeat with a spatial period greater than a length of the anti-tamper film required to close the container.

8. The equipment according to claim 2, comprising a weighing device, configured to determine a weight of the container.

9. The equipment according to claim 8, wherein the weighing device comprises a processing module, weight sensors, arranged so as to be loaded by the container connected to the frame, and an inclinometer, and wherein the processing unit is configured to determine the weight of the container on the basis of a response of the weight sensors and a response of the inclinometer.

10. The equipment according to claim 8, wherein the processing unit is configured to estimate a product volume inside the container from the reference image acquired and to determine the weight of the container based on the estimated volume and of product information stored in the storage device.

11. The equipment according to claim 8, wherein the image detector device is activatable to acquire a final reference image of the container in response to a weight reduction detected by the weighing device and the processing unit is configured to associate the final reference image with respective coordinates detected by the satellite positioning device and a respective timestamp and to store the final reference image, the coordinates detected by the satellite positioning device, and the timestamp in the storage device.

12. The equipment according to claim 8, wherein the image detector device is activatable in response to a manual command receivable through a command interface and to acquire a final reference image of the container and the processing unit is configured to associate the final reference image with respective coordinates detected by the satellite positioning device and a respective timestamp and to store the final reference image, the coordinates detected by the satellite positioning device, and the timestamp in the storage device.

13. The equipment according to claim 11, wherein the image detector device is configured to acquire a control image of the container in response to a command of the processing unit and wherein the processing unit is configured to:
compare the control image and the final reference image associated with the container and stored in the storage device; and
apply programmed tolerance thresholds; and
confirm or deny that the control image and the final reference image, associated with the container and stored in the storage device, are identical based on the comparison and on the tolerance thresholds.

14. The equipment according to claim 7, claim 2, comprising:
a dispenser supplying an anti-tamper film, applicable to close the container, the anti-tamper film having, on one face, graphic signs that do not repeat or repeat with a spatial period greater than a length of the anti-tamper film required to close the container; and
a weighing device, configured to determine a weight of the container, wherein the image detector device is activatable to acquire a final reference image of the container in response to a weight reduction detected by the weighing device and the processing unit is configured to associate the final reference image with respective coordinates detected by the satellite positioning device and a respective timestamp and to store the final reference image, the coordinates detected by the satellite positioning device, and the timestamp in the storage device;
wherein the image detector device is configured to acquire a control image of the container in response to a command of the processing unit and wherein the processing unit is configured to:
compare the control image and the final reference image associated with the container and stored in the storage device; and
apply programmed tolerance thresholds; and
confirm or deny that the control image and the final reference image, associated with the container and stored in the storage device, are identical based on the comparison and on the tolerance thresholds; and
wherein the processing unit is configured to recognize and compare the graphic signs of the control image and of the final reference image associated with the container and stored in the storage device.

15. The equipment according to claim 2, wherein the storage device contains admissible values for recognition parameters for identifying agri-food product units, and the processing unit is configured to identify the presence of objects not compatible with the admissible values for the recognition parameters.

16. The equipment according to claim 2, wherein the container is a stackable picking box and the connecting members comprise a stackable box identical to the container.

17. The equipment according to claim 1, wherein the image detector device is configured to acquire a landscape image around the frame in response to a command of the processing unit and the processing unit is configured to request the acquisition of a landscape image in response to a coordinate change detected by the satellite positioning device.

18. The equipment according to claim 1, comprising a wireless communication module configured to communicate with a remote station.

19. A system for the traceability of agri-food products, comprising at least one piece of equipment according to claim 1 and a remote station comprising a database, wherein the processing unit of each piece of equipment is configured to store in the database the images acquired by the respective image detector device with the respective timestamp and with the coordinates detected by the respective satellite positioning device.
